(19) United States
(12) Patent Application Publication
(10) Pub. No.: US 2009/0078902 A1
(43) Pub. Date: Mar. 26, 2009

(54) Aerosol valve

(75) Inventor: Randy J. Flynn, Oshawa (CA)

Correspondence Address: KILGANNON & STEIDL, 85 Pondfield Road, Bronxville, NY, 10708, US

(73) Assignees: Precision Valve Canada Ltd.; Precision Valve Corporation

(21) Appl. No.: 11/904,253

(22) Filed: Sep. 26, 2007

(51) Int. Cl. B65D 83/46; B65D 83/14; B23P 11/00

(52) U.S. Cl. 251/149.8; 251/349; 29/890.124; 222/402.22

(57) ABSTRACT

An aerosol valve for dispensing polyurethane foam including a plastic liner shield to prevent environmental moisture permeating through the sealing grommet into the aerosol can to harden product and disable the valve. The liner has an annular upper portion in the mounting cup channel for sealing to the can bead, an intermediate portion surrounding the grommet in the can, and a lower annular flange extending between the valve stem base and lower grommet surface. A method to assemble the valve components includes inversion of the liner, grommet, valve stem, and mounting cup.

### FIELD OF THE INVENTION

The present invention relates to aerosol valves of the type operated to dispense polyurethane aerosol foam. More particularly, the present invention relates to an aerosol valve having a valve stem captured by an annular sealing grommet which in turn is captured by a valve mounting cup.

### BACKGROUND OF THE INVENTION

Prior art aerosol valves of the above type generally comprise a resilient rubber (i.e. Neoprene) grommet that extends through the central opening in the panel of the metal mounting cup. An annular expanded portion of the grommet extends below the mounting cup and has an upper surface that seals against the lower surface of the panel of the mounting cup. The grommet also has an annular portion extending above the mounting cup panel, and a central bore passing through the grommet from top to bottom. Situated in the central bore and extending above and below the grommet is a plastic valve stem. The valve stem has an annular base portion of larger circumference than the upstanding portion of the valve stem, with the upper surface of the base portion sealing against the lower surface of the grommet inside the aerosol container when the aerosol valve is not actuated. The valve stem above its base has a central bore and side lateral openings through the stem side wall into the stem bore. The mounting cup has an annular wall upstanding from the outside perimeter of its panel portion and terminating in an outer annular channel portion which is crimped in conventional fashion about the annular aerosol can bead defining the top opening of the aerosol can. The aerosol can is filled with the polyurethane product. When the user wishes to dispense the product from the aerosol can, the upstanding valve stem is tilted (or may be vertically depressed), thus having a portion of the stem base upper surface separate from sealing the bottom surface of the grommet. The polyurethane product is then forced by propellant pressure in the aerosol can to flow between the separated surfaces through the valve stem side lateral openings and up through the stem central bore to exit the aerosol valve to the area where the polyurethane foam is being applied.

The above form of aerosol valve has been widely adopted, but is known to have a problem of occasional valve sticking when used to dispense polyurethane aerosol foam. Polyurethane foam after it is dispensed from the can and valve will of course desirably cure and harden. However, if moisture is present in the can, this curing will begin to occur in the can itself and can result in a stuck aerosol valve such as to render the purchased product useless to the consumer.

A source of moisture occurring in the aerosol can of the polyurethane product is believed to be environmental moisture in the air outside the can. This moisture can permeate the grommet seal due to the portion of the grommet extending into the environment outside the can and mounting cup. Since a portion of the grommet seal also extends inside the can under the mounting cup, the permeated moisture can egress from the grommet inside the can to come in contact with the active ingredient of the polyurethane product inside the can. Thus, curing and hardening may begin inside the can resulting in the stuck aerosol valve and the failed product.

Various attempts have been made to overcome the above problem, such as by mechanical structure or by using at least in part a grommet material which is not susceptible to moisture ingress and egress. These attempts are not particularly successful and/or costly to use in manufacturing the aerosol valve, etc.

### SUMMARY OF THE INVENTION

The present invention is intended to provide a solution to the above problem of environmental moisture permeating the grommet seal and entering the can of polyurethane product. A plastic, shaped, annular liner shield and seal is incorporated into the aerosol valve, the liner having a central opening, an outer terminal annular portion extending into the mounting cup annular channel, and an intermediate annular liner portion extending downwardly from the liner outer terminal portion. The plastic liner intermediate portion extends downwardly along the upstanding wall portion of the mounting cup, surrounds the portion of the resilient grommet positioned below the mounting cup panel, and terminates in an inwardly extending annular flange positioned between a bottom grommet surface and an upper surface of the stem base. In this manner, while environmental moisture may still enter the grommet through its upper portion extending above the mounting cup panel, that moisture is prevented from egressing from the grommet into the product in the aerosol can due to the liner shield. The liner therefore eliminates the problem of valve sticking in a simple manner without substantially increased cost and manufacturing difficulty.

An additional feature and benefit of the present invention is obtained in the sealing of the mounting cup channel portion to the can bead. As described above, the liner shield has its outer terminal annular portion extending into the mounting cup channel, so that when the channel portion is crimped onto the can bead, the liner is thereby mounted on the valve and held in place. Further, the liner's outer terminal annular portion may serve as a sealant between the mounting cup channel and can bead, to thereby avoid the need for cut, laminate or sleeve gaskets normally used as seals at that position.

Other features and advantages of the present invention will be apparent from the following description, drawings and claims.

### BRIEF DESCRIPTION OF THE DRAWINGS

FIG. 1 is a cross-sectional view of the assembled aerosol valve of the present invention taken diametrically through the central axis of the aerosol valve;

FIG. 2 is a cross-sectional view corresponding to FIG. 1 of the mounting cup component of the present invention;

FIG. 3 is a side elevation of the valve stem component of the present invention;

FIG. 4 is a cross-sectional view corresponding to FIG. 1 of the grommet component of the present invention;

FIG. 5 is a bottom plan view of the liner component of the present invention;

FIG. 6 is a cross-sectional view of the liner component of the present invention, taken along lines 6-6 of FIG. 5;

FIG. 7 is a side elevation of the liner component of the present invention; and

FIG. 8 is a perspective view of the liner component of the present invention.

### DETAILED DESCRIPTION OF EMBODIMENTS

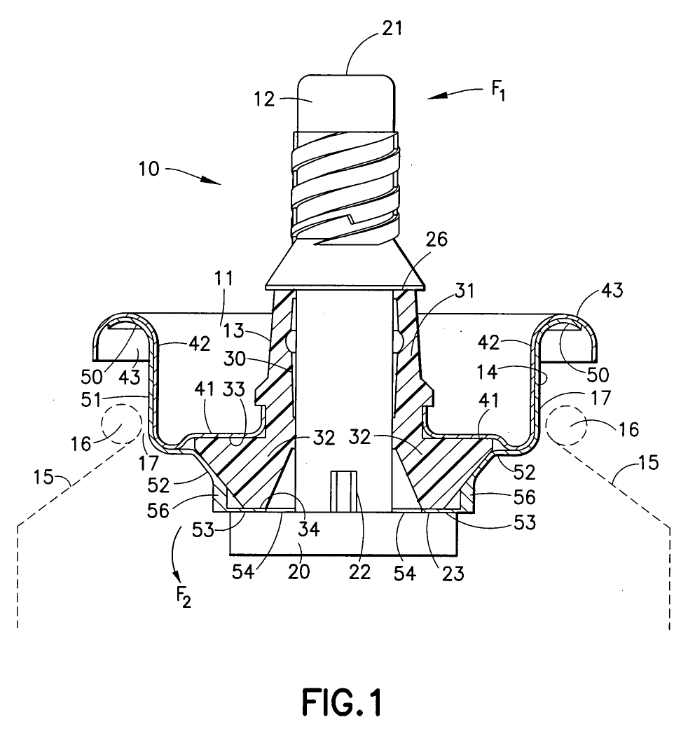

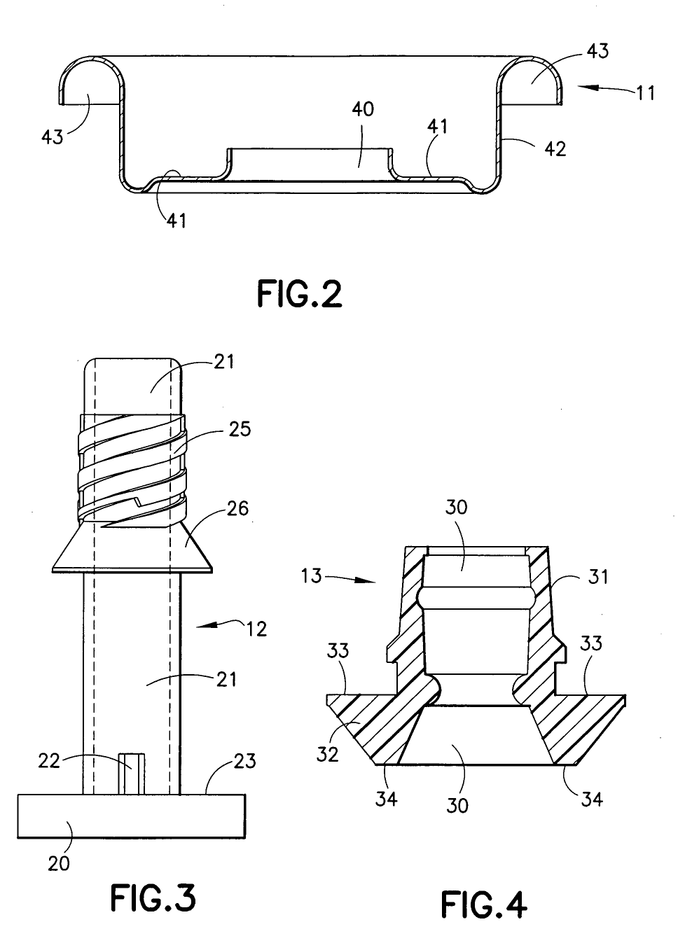

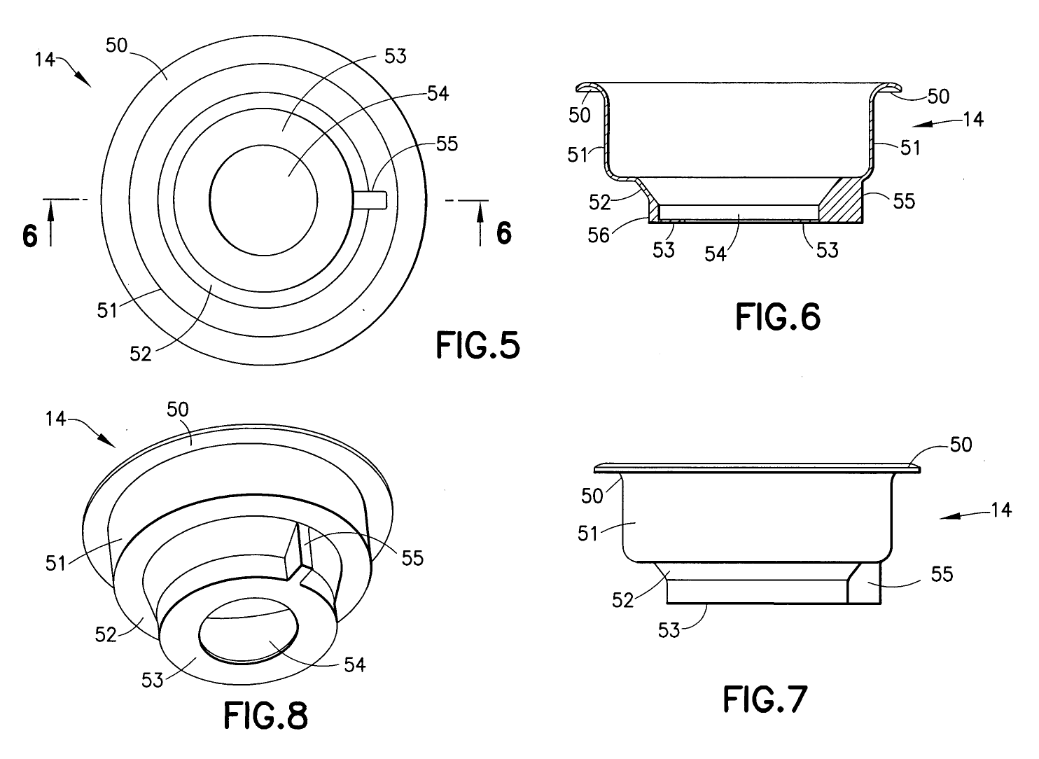

Referring to FIG. 1, aerosol valve 10 is shown in its assembled condition. Aerosol valve 10 is comprised of annular metal mounting cup 11 (see FIG. 2), plastic (i.e., polypropylene) valve stem 12 (see FIG. 3), annular resilient Neoprene grommet 13 (see FIG. 4) and annular plastic liner 14 (see FIGS. 5, 6, 7 and 8). FIG. 1 illustrates aerosol valve 10 in its closed, non-actuated, position. Aerosol valve 10 is intended to be mounted on the top of aerosol can 15 which has an annular bead 16 defining a top opening 17 of the aerosol can 15. Can 15 is intended to include the ingredients of a polyurethane foam product or the like, which when dispensed by the aerosol valve will cure and harden when exposed to the environment outside of the aerosol can. Can 15 may be turned upside down in normal use dispensing product.

Valve stem 12 (also see FIG. 3) has a diametrically enlarged annular base portion 20, a center bore 21 for product dispensing and lateral side opening 22 through the stem side wall. Base portion 20 has an upper surface 23. In the FIG. 1 closed position, product in can 15 is blocked from entering stem 12 due to stem base 20 sealing up against a portion of liner 14 interposed between grommet 13 and stem base 20 as hereafter described. However, when stem 12 is tilted for example in the direction of F1 by the user, one side of stem base 20 (the left side for example) will swing downwardly in the direction of F2 shown in FIG. 1. That side of base 20 therefore separates at its top surface 23 from sealing against liner 14 and the product in aerosol can 15 under the influence of propellant in can 15 will pass over stem base 20 into lateral stem openings 22 and up stem bore 21 to exit into the environment. This dispensing of course will continue until stem 12 is released to no longer tilt, or until can 15 is empty of its product. Stem 12 may have threads 25 around its circumferences if desired in order to screw on a dispensing fixture, but such is not necessary. Stem 12 instead may have a fitment on top that when actuated depresses stem 12 vertically instead of tilting the stem. Stem 12 may also have an annular flange 26 abutting against the top of grommet 13 when assembled thereto.

Grommet 13 (also see FIG. 4) is a resilient member having a center bore 30 extending therethrough into which stem 12 is pushed through from the grommet bottom so that grommet 13 surrounds a portion of stem 12. When pushed all the way through, grommet 13 is essentially captured between the flange 26 and the base 20 of the valve stem 12. Grommet 13 has an upstanding portion 31 and a diametrically enlarged base portion 32. Base portion 32 has a top surface 33 and a bottom surface 34.

Annular mounting cup 11 (also see FIG. 2) has a central opening 40, an annular intermediate panel portion 41, an upstanding annular wall 42, and a peripheral annular channel 43. Upon assembly to aerosol can 15, channel 43 is sealingly crimped around annular can bead 16 defining the can top opening. Grommet 13 with enclosed valve stem 12 is mounted through the central opening 40 of mounting cup 11 and is held therein. Top wall 33 of grommet expanded base portion 32 is sealingly pressed up against the lower surface of mounting cup panel 41.

Turning now to the essential liner component of the present invention, and referring to FIGS. 1 and 5-8, liner 14 is comprised of an annular top flange portion 50, an upper annular intermediate portion 51, a lower annular intermediate portion 52, and a bottom annular flange portion 53 defining liner central opening 54 therein. Protrusion or rib 55 extends outwardly from lower intermediate portion 52 and serves solely as a gate platform for the hot runner probe in the injection molding of liner 14. Liner 14 as injection molded is a thin plastic member of impact polypropylene copolymer resin, for example, and while flexible, has a stand-by-itself spatial shape as shown. The lower intermediate portion 52 has a thickened annular section 56 at its bottom in order to provide structural stability to liner 14 during molding and operation.

Referring back to FIG. 1 showing the assembled aerosol valve 10, annular top flange 50 of liner 14 fits inside annular channel portion 43 of the mounting cup and acts as a sealant between the mounting cup channel 43 and the bead 16 of can 15 when the aerosol valve 10 is mounted to the can bead by crimping channel 43 about can bead 16. Top flange 50 of liner 14 is believed to be sufficient to perform the sealing feature by itself, but additional known sealants may also be used if desired. Upper intermediate portion 51 of liner 14 extends downwardly along the upstanding annular wall 42 of the mounting cup, and lower intermediate portion 52 of liner 14 extends downwardly to surround the lower portion 32 of grommet 13. Bottom annular flange 53 of liner 14 extends under the grommet up against the bottom 34 of the grommet lower portion 32. In this assembled condition of aerosol valve 10 as shown in FIG. 1 and with aerosol valve 10 mounted and crimped on the top of aerosol can 15 with can bead 16, environmental moisture outside of aerosol valve 10 and can 15 can permeate into upper portion 31 of grommet 13 and down into lower portion 32 of grommet 13. However, liner 14 acts as a shield around the outer and lower surfaces of lower portion 32 of grommet 13 in the can, and that moisture has no path into can 15 and the polyurethane product contained therein. The polyurethane product therefore will not begin to cure and harden adjacent the lower part 20 of the valve stem so as to lock the valve stem and prevent any further use. The saving to the buyer is obvious in that an unusable can of polyurethane foam does not have to be discarded.

The components of aerosol valve 10 are easily assembled. Grommet 13 may be turned upside down (inverted) from its FIG. 4 upright position. Liner 14 is then turned upside down from the upright position of FIGS. 6, 8, and the inverted liner 14 is then placed and centered over the inverted grommet 13 so that the bottom liner flange 53 abuts the bottom of grommet portion 32 (i.e., as in an upside down position of FIG. 1 if inverted). Stem 12 of FIG. 3 is then inverted from the upright position of FIG. 3 and pushed down through center bore 30 of inverted grommet 13 so that flange 53 of liner 14 is held between surface 23 of stem base 20, and surface 34 of grommet portion 32 (i.e., as in an upside down position of FIG. 1 if inverted). Mounting cup 11 of FIG. 2 is now inverted from the upright position of FIG. 2, and the inverted sub-assembly of grommet 13, liner 14, and stem 12 is inserted downwardly into the stationary inverted mounting cup. The resulting entire assembled aerosol valve 10 including mounting cup 11 is then inverted to arrive at the FIG. 1 positioning.

It will be appreciated by persons skilled in the art that variations and/or modifications may be made to the present invention without departing from the spirit and scope of the invention. The present embodiments are, therefore, to be considered as illustrative and not restrictive. It should also be understood that positional terms as used in the specification are used and intended in relation to the positioning shown in the drawings, and are not otherwise intended to be restrictive.

What is claimed is:

1. An aerosol valve for dispensing polyurethane foam and the like, comprising a mounting cup, a valve stem, a grommet seal and a liner; the mounting cup including a central opening, an intermediate panel surrounding the central opening, an upstanding wall, and an outer annular channel to be mounted on the bead surrounding the top opening of an aerosol container; the grommet seal including a central bore and being a resilient member mounted and retained in the central opening of the mounting cup, said grommet having an upper portion extending above the mounting cup central opening, and having a lower portion extending below the mounting cup central opening and underlying the mounting cup panel; the valve stem having a base portion underlying the grommet lower portion and having a stem portion extending upwardly through and out of the central bore of the grommet; the liner comprising an upper portion extending into the annular mounting cup channel for sealing the mounting cup channel, an intermediate portion downwardly extending along the mounting cup and surrounding the lower portion of the grommet, and a lower portion comprising an annular flange extending between and sealing the bottom of the grommet and the valve stem base portion when the aerosol valve is not actuated; whereby the grommet is isolated from the material inside the aerosol can when the valve is installed on the can, and environmental moisture passage through the grommet into the aerosol container is essentially eliminated.

2. The aerosol valve of claim 1 wherein the liner is formed of polypropylene copolymer.

3. The aerosol valve of claim 1, wherein the grommet seal is formed of neoprene.

4. The aerosol valve of claim 1, wherein the aerosol valve may be actuated by tilting and said valve stem has a central bore for product flow and side orifices for product flow into the stem central bore when the stem is actuated.

5. The aerosol valve of claim 1, said liner intermediate portion having a thickened annular wall adjacent said liner lower portion annular flange.

6. A method of assembling an aerosol valve, the valve components comprising a mounting cup, a valve stem, a grommet seal and a liner; the mounting cup having a central opening, an intermediate panel, an upstanding wall, and an outer annular channel; the grommet having a central bore, an upper portion to extend above the mounting cup central opening, and a lower portion to extend below the mounting cup central opening and underlie the mounting cup panel; the valve stem having a base portion to underlie the grommet lower portion and having a stem portion to extend through the grommet central bore; and a liner comprising an upper portion, an intermediate portion to surround the lower portion of the grommet, and a lower portion terminating in an annular flange to extend between and seal the bottom of the grommet and the valve stem base portion when the aerosol valve is not actuated; wherein the method of assembling the valve components comprises inverting the grommet from its upright position; inverting the liner from its upright position; centering and placing the inverted liner over the inverted grommet; inverting the stem from its upright position and pushing the stem through the inverted grommet central opening until the stem base portion captures the liner annular flange between the stem base portion and the grommet base portion; inverting the mounting cup from its upright position; and, inserting the sub-assembled inverted grommet, liner and stem downwardly into the stationary inverted mounting cup to complete the assembled valve in a position inverted from its normal upright position when mounted on the top of the aerosol can.
